(19) United States
(12) Patent Application Publication
(10) Pub. No.: US 2011/0008077 A1
(43) Pub. Date: Jan. 13, 2011

(54) SCALABLE PRINTING SYSTEM HAVING MULTIPLE INTERMEDIATE TRANSFER BELTS

(75) Inventor: Steven R. Moore, Pittsford, NY (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: XEROX CORPORATION, Norwalk, CT (US)

(21) Appl. No.: 12/499,461

(22) Filed: Jul. 8, 2009

(51) Int. Cl. G03G 15/01

(52) U.S. Cl. 399/302

(57) ABSTRACT

A printing system for creating multi-color images on print media. The printing system includes a plurality of marking modules, wherein each marking module creates a single color separation of a multi-color image. The printing system also includes a first image collection member that collects superimposed color separations produced by a first set of marking modules and a second image collection member that collects superimposed color separations produced by a second set of marking modules. The printing system further includes a media transport that conveys print media along a defined direction. A first set of color separations is simultaneously transferred from the first image collection member to a print media at a first location on the transport and a second set of color separations is simultaneously transferred from the second image collection member to the media at a second location on the transport. Further, at least one of the sets of color separations consists of at least two color separations.

### BACKGROUND

The systems and methods disclosed herein are related to the art of image rendering devices such as printers and copiers. Embodiments will be described in terms of laser-based electrophotographic marking engines, such as those used in printers, photocopiers and facsimile machines. However, embodiments are applicable to other rendering devices, such as those that present image data in raster lines including display devices and other kinds of printers.

By way of background, a base marking module in a xerographic printing system is capable of creating a single color separation. A printing system may be constructed from 1 to N of these marking modules, along with supporting input and output modules and any other necessary infrastructure. It is thus possible to create printing systems having 6 or more available color separations. Some systems may have 7 or even 8 different color separations. It is thus possible to construct a highly modular system having a single intermediate transfer belt (ITB) and up to 8 or more color toner first transfer nips. However, there is unavoidable image degradation as the image being built on the ITB passes through the multiple downstream toner transfer nips associated with the downstream marking modules. One aspect of the degradation is termed “retransfer,” wherein toner on the top layer of the ITB experiences shifts in its charge in a downstream toner transfer nip and transfers back to a downstream photoreceptor. This retransfer effect can cause hue shifts and non-uniform effects in the final color image.

It is therefore desirable to offer an N-color modular printing system while mitigating this effect.

### INCORPORATION BY REFERENCE

The following reference, the disclosure being totally incorporated herein by reference, is mentioned:

U.S. Patent Publication No. 2009/0022525 by Martin et al., entitled “HYBRID PRINTING SYSTEM,” discloses a single-pass hybrid color and black printing system for producing multi-color images as well as black images.

### BRIEF DESCRIPTION

Described herein is a modular printing system architecture consisting of base marking modules, each capable of creating a single color separation which is deposited onto an intermediate transfer belt (ITB) at a toner first transfer nip, to create a multi-color image having up to a preset maximum number of colors. The system is described with the assumption that the preset limit is 4 colors per ITB, although it is to be understood that other limits could be applied. If more than the preset limit of colors is needed for the printing system, an additional ITB can be added to the printing system having up to its preset limit of additional colors. A full color image is built up onto the media via serial toner second transfer nips with each of the ITBs. It is known that a color separation transferred to an intermediate surface at an upstream location will be degraded as it passes through successive downstream toner transfer nips which are transferring different color toners to the intermediate. This image degradation is referred to herein as “retransfer,” since toner already on the intermediate will to some degree transfer back onto each downstream photoreceptor at each downstream toner transfer nip. This architecture will reduce the retransfer stress. For example, an 8-color system composed of two 4-color ITBs would have a worst case of four downstream transfer nips (three toner first transfer ITB nips plus one toner second transfer nip). By comparison, an 8-color system with a single ITB would have a worst case of 7 downstream first transfer nips contributing to retransfer. Additionally described herein is a modular printing architecture in which at least one of the ITB modules is replaced by a photoreceptor belt or drum onto which up to a preset maximum number of color separations are imaged and developed.

In accordance with an aspect of the exemplary embodiments, a printing system is provided. The printing system includes a plurality of marking modules, wherein each marking module creates a single color separation of a multi-color image. The printing system also includes a first image collection member that collects superimposed color separations produced by a first set of marking modules and a second image collection member that collects superimposed color separations produced by a second set of marking modules. The printing system further includes a media transport that conveys print media along a defined direction. A first set of color separations is simultaneously transferred from the first image collection member to a print media at a first location on the transport and a second set of color separations is simultaneously transferred from the second image collection member to the media at a second location on the transport. Further, at least one of the sets of color separations consists of at least two color separations.

In accordance with another aspect of the exemplary embodiments, a method of creating multi-color images on print media in a printing system is provided. The method includes creating color separations of a multi-color image via a plurality of marking modules, wherein each marking module creates a single color separation, collecting superimposed color separations produced by a first of said marking modules via a first image collection member, collecting superimposed color separations produced by a second set of marking modules via a second image collection member, and conveying print media along a defined direction in the printing system with a media transport. The method further includes simultaneously transferring a first set of color separations from the first image collection member to a print media at a first location on said transport and a second set of color separations from the second image collection member to the media at a second location on the transport, wherein at least one of the sets of color separations comprises at least two color separations.

### BRIEF DESCRIPTION OF THE DRAWINGS

FIG. 1 shows a xerographic marking module that is capable of placing a single color separation onto an ITB.

FIG. 2 shows a single pass image-on-image color printing system.

FIG. 3 shows a base architecture in accordance with aspects of the exemplary embodiments.

FIG. 4 illustrates how the architecture of FIG. 3 can be expanded to create a 6-color printer.

FIG. 5 shows how the architecture can be extended to an 8-color system.

### DETAILED DESCRIPTION

In the following description, reference is made to the drawings. In the drawings, like reference numerals have been used throughout to designate identical elements. Although embodiments will be described with reference to the embodiment shown in the drawings, it should be understood that embodiments may be employed in many alternate forms. In addition, any suitable size, shape or type of elements or materials could be used without departing from the spirit of the exemplary embodiments.

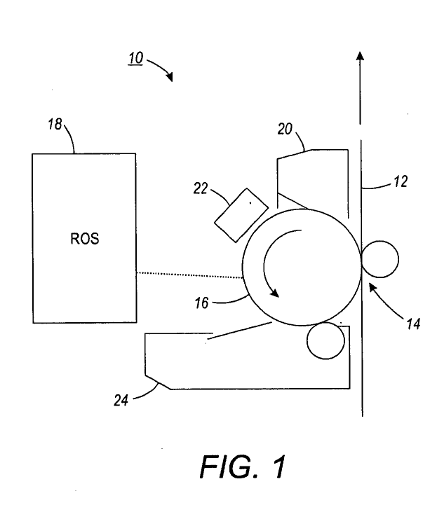

FIG. 1 shows an example of a xerographic marking module 10 that is capable of placing a single color separation onto an intermediate transfer belt (ITB) 12. The ITB 12 is shown oriented vertically in FIG. 1, although horizontal layouts are equally possible

Xerographic marking is typically performed in cycles by exposing an image of an original document onto a substantially uniformly charged photoreceptive member (P/R) 16. The photoreceptive member 16 has a photoconductive layer. A charging device 22 initially applies a uniform electric charge onto the photoconductive layer either through contact or non-contact means. Exposing the charged photoreceptive member 16 with the image with a raster output scanner (ROS) or LED bar 18 discharges areas of the photoconductive layer corresponding to non-image areas of the original document while maintaining the charge in the image areas. In discharge area development, the reverse is true where the image areas are the discharged areas and the non-image areas are the charged areas. Thus in either case, a latent electrostatic image of the original document is created on the photoconductive layer of the photoreceptive member 16.

Charged developing material is subsequently deposited by a developer 24 on the photoreceptive member 16 to develop the latent electrostatic image areas. The developing material may be a liquid material or a dry (powder) material. The charged developing material is attracted to the charged image areas on the photoconductive layer. This attraction develops the latent electrostatic image into a visible toner image. The visible toner image is then transferred from the photoreceptive member 16 to the ITB 12 within the first transfer nip 14. The first transfer nip 14 generates an electric field capable of moving toner from the photoreceptive member 16 onto ITB 12. Subsequently, the image is transferred to a copy sheet or other support substrate as an unfused toner image, which is then heated and permanently affixed to the copy sheet, resulting in a reproduction or copy of the original document. In a final step, the photoconductive surface of the photoreceptive member 16 is cleaned with a cleaner 20 to remove any residual developing material in order to prepare it for successive imaging cycles.

In a conventional tandem color printing process, four marking modules 10 may be used. Photoconductive drum marking modules are typically employed in tandem color printing due to the compactness of the drums. A tandem system can alternatively use four photoconductive imaging belts instead of the drums. Each imaging drum or belt system charges the photoconductive surface thereof, forms a latent image on the thereon, develops it as a toned image and then transfers the toned image to an intermediate belt or to a print media. In this way, yellow, magenta, cyan, and black single-color toner images are separately formed and transferred onto the intermediate surface. The intermediate surface 12 thus serves as an image collection member in that, when superimposed, these four toned images can then be transferred to print media and fused, and is capable of resulting in a wide variety of colors.

In an alternative printing process, a multiple pass imaging process can be used to create the necessary color separations. In such a system, a single photoreceptive member 16 is used to serially create the multiple charged images. Typically developer 24 is rapidly switchable between the different color toners so that the different color toner images can be produced in succession. Each single-color toner image is then serially transferred to a recirculating intermediate transfer belt (ITB) or drum 12 and thus superimposed over the other, which results in a single multi-color toner image created on the intermediate surface. The single multi-color toner image is then transferred onto the copy sheet at a second transfer station.

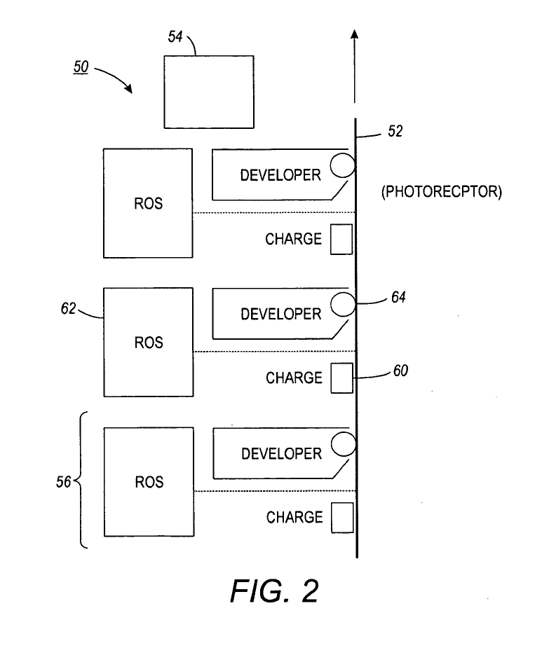

In an alternative printing process using a single pass image-on-image color printing system 50, as shown in FIG. 2, an endless photoreceptor belt or drum 52, a controller 54 and a series of imaging subassemblies 56 are employed that may each include a charging unit 60, a color separation latent image exposure ROS unit or LED print bar 62, and a corresponding color toner development unit 64. As the photoreceptive member moves past an imaging subassembly, an image frame thereon is charged, exposed and developed, in succession, by each imaging subassembly, with each imaging subassembly thus forming a color separation image corresponding to color separation image input video data from the controller onto the photoreceptor. After the first imaging subassembly forms its color separation toner image, that color separation toner image is then recharged and re-exposed to form a different color separation latent image, and then correspondingly developed by the next imaging subassembly. After the final color separation image is thus formed, the fully developed multi-color image is then ready to be transferred from the image frame at a second transfer station to a print media. Thus in system 50, the photoreceptive member 52 acts as the image collection member as opposed to system 10 wherein the intermediate member 12 acts as the image collection member.

In accordance with the exemplary embodiments described herein, the print media is brought into the image collection member at a second transfer station. At the second transfer station, a combination of electric field, mechanical pressure, and heat may be used to cause the superimposed toner image upon the image collection member to move onto the media surface.

The marking module 10 can be replicated within a printing system to create N-color printing capability. One approach for creating a scalable system would be to configure a single ITB module that is scalable in size so that 1 to N marker modules could be integrated within the ITB. By providing a scalable structure for the ITB belt, and by providing a suitably long belt, it is thus possible to construct a 4, 6, or even 8 color printing system. However, there are several issues with such an approach. For instance, an ITB belt and an ITB module can become so large as to be cumbersome for field service operations. Also, a system with N colors requires that the first color separation placed onto the ITB must pass through N−1 downstream first transfer nips, which is known to result in image quality problems to be further explained.

The solution described herein is to provide a printing architecture that can support multiple ITBs. By providing multiple ITBs, the size of the ITB belt and its support structure can be kept manageable. Further, the worst case number of transfer nips that can cause retransfer is reduced.

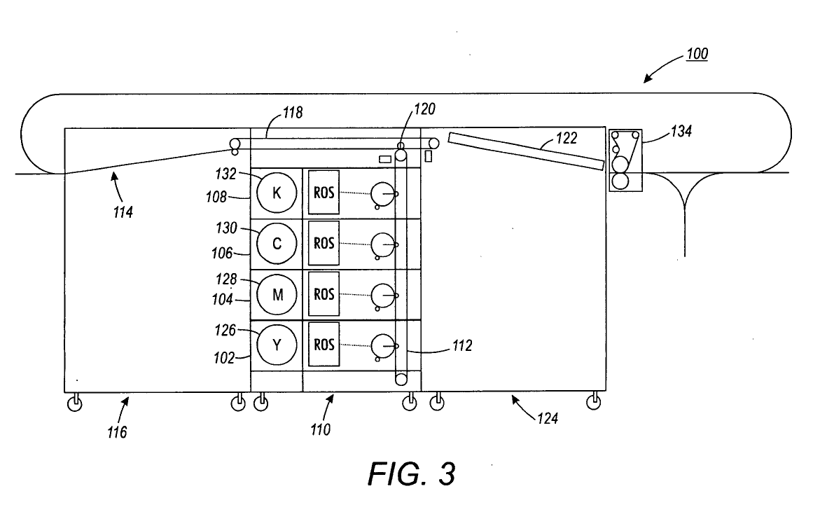

FIG. 3 represents a schematic of an exemplary xerographic printing system 100 which is capable of 4-color printing. As shown in FIG. 3, four marking modules numbered as 102, 104, 106 and 108 are shown contained within an ITB “backplane” module 110. Within the ITB backplane module 110, each of the four marking modules contributes a separate color separation onto the vertically oriented ITB 112, i.e., 102—yellow (Y), 104—magenta (M), 106—cyan (C), and 108—black (K). The media passes from left to right through, respectively, a sheet registration transport 114 (contained in the left module 116) that aligns the incoming media sheet with respect to the superimposed toner image; an electrostatic tacking transport 118 with a second transfer nip 120 incorporated therein (contained in the center ITB backplane module 110) that conveys the media sheet without slippage; and a vacuum isolation pre-fuser transport 122 (contained in the right module 124) that receives the sheet from transport 118 and limits its drive force acting on the sheet so that velocity disturbances of transport 118 are minimized during handoff The four circles (numbered as 126, 128, 130, and 132) oriented vertically on the left side of the ITB backplane module represent toner bottles Y, M, C and K, respectively. A belt roll fuser 134 is shown to the right of the third module 124.

In FIG. 3, each toner is successively moved from its respective marking module onto the intermediate belt surface. This is called “forward transfer.” which is a desirable process. But at practical field levels for forward transfer, some of the toner already on the belt will transfer back to each downstream drum. This is called “retransfer,” which is an undesirable process. The retransfer occurs because the charge level of the toner already on the belt is altered when it passes through another first transfer nip. Some of the toner particles experience enough of a charge level change that they respond oppositely to our intent, thus they will transfer from the belt to the drum. As the built up image on the belt passes through additional first transfer nips, this behavior repeats itself. Thus, some of the yellow toner will be “lost” onto the magenta, cyan, and black drums. As can be appreciated, this can cause hue shifts and non-uniform effects.

Each first transfer nip therefore has two functions: 1) to maximize forward transfer of toner; and 2) to minimize retransfer of toner. There is a tradeoff between the two functions; as the electric field strength is increased to improve forward transfer, more toner particles are also generate that will retransfer to the drum. At the top of the ITB module 112 is an interface to the paper, which is called the second transfer nip 120. At this point, it is desirable for all of the toner on the belt 112 to transfer on to the paper. Because there is no toner on the paper, there can be no retransfer of toner. Thus an electric field strength that optimizes forward transfer of toner from belt to paper can be selected.

Now suppose one wants to create a six color image. A conventional approach would be to make a large ITB module having six marking modules. Now the first color layer applied to the belt will pass through five first transfer nips and will experience retransfer at each one. An eight color printer constructed this way would expose the first color to seven opportunities for retransfer before the toner is finally transferred to the paper. It would be desirable to construct an N-color printing system without incurring N−1 opportunities for retransfer.

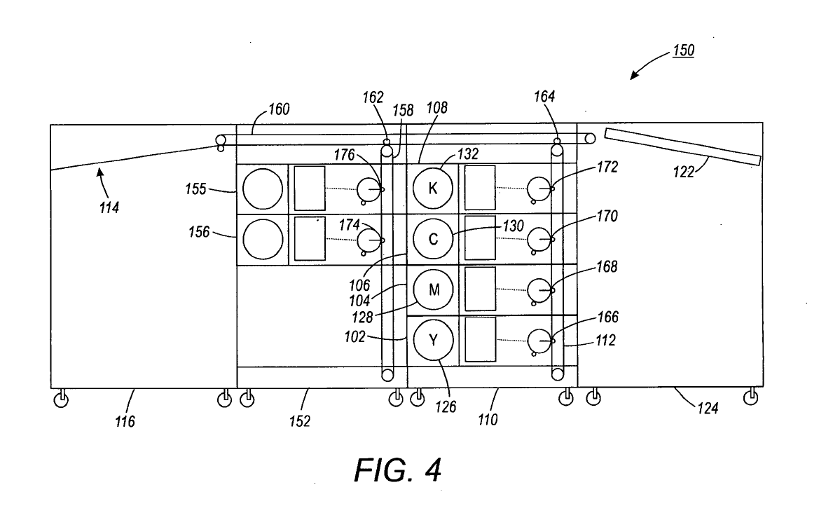

FIG. 4 shows an expanded printing system 150 comprising a 6-color printer. In particular, a second ITB backplane module 152 has been added to the system 100 of FIG. 3. The second ITB backplane module 152 is configured with two additional marking modules 155 and 156 operating with a second ITB belt 158. The additional marking modules 155 and 156 can contain specialized color toners that are dependent upon the printing application. For printing of high resolution photographs, for example, low intensity magenta and cyan toners can be employed to improve the image smoothness and reduce graininess. By way of example, for general printing with increased color gamut range, orange and violet toners can be employed to extend the color range beyond the range afforded by C, M, Y, and K toners. For other printing applications, clear, white, and magnetic toner (MICR) may be desired. The media now passes along an elongated electrostatic tacking transport 160, which escorts sheets through two serial second transfer nips 162, 164. In addition, the media receives toner images produced along the first ITB belt 112 through four serial first transfer nips (166, 168, 170, 172) and along the second ITB belt 158 through two serial first transfer nips (174, 176). Thus, multiple ITB backplanes may be used to provide N-color scalability. Color-to-color registration between all 6 separations can be achieved by assuring that media motion between the two second transfer nips is stable and repeatable. This is readily achieved via the electrostatic tacking transport shown. Note that the bottom-most marking modules within each of the ITB backplanes will see the greatest retransfer effect since their images will pass through the most downstream transfer nips. The worst case stress for the left-hand backplane module 152 will be two downstream nips (one first transfer nip 176 plus the downstream second transfer nip 164). The worst case stress for the right-hand backplane module 110 will be three downstream nips (three first transfer nips 168, 170, 172). By comparison, for a single ITB with six marking modules the worst case is five downstream nips.

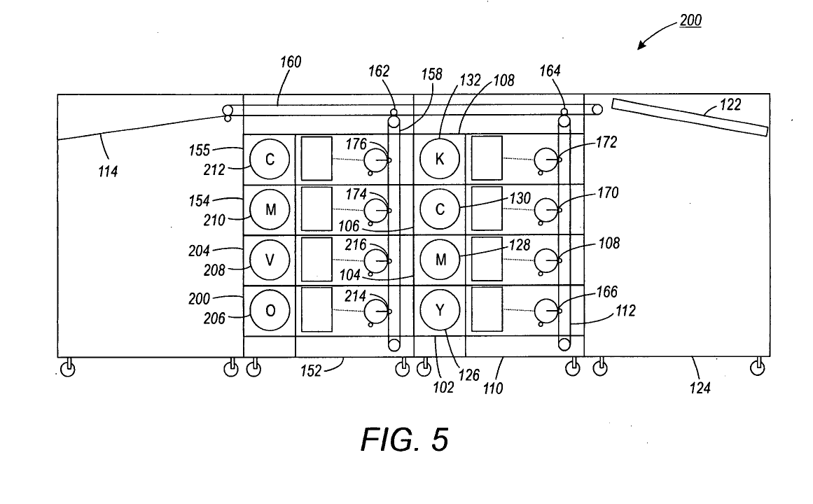

FIG. 5 shows two separate 4-color ITB modules 110, 152 joined via an electrostatic tacking transport 160 forming an 8-color system 200. This may be accomplished by simply fully populating the left-hand ITB backplane 152 with two more marking modules 200, 204. Module 110 may contain C, M, Y, and K toners so that conventional 4-color images may be transferred to print media at second transfer nip 164. Up to 4 additional colors can be transferred to the print media at second transfer nip 162. To assemble a four color image using the left backplane module 152, each of the four drums will transfer a color separation onto the ITB belt 158. In this example, the bottom marking module 200 is applying the orange (O) separation, the next marking module up (204) violet (V), the next marking module (154) low intensity magenta (m), and the top marking module 155 applies low intensity cyan (c). The point where the orange drum contacts the ITB belt 158 is called a first transfer nip 214. There are four first transfer nips (214, 216, 174, 176), one for each separation color. At the orange first transfer nip 214, orange toner is transferred from the drum onto the ITB belt 158. The belt 158 proceeds upward and arrives at the violet first transfer nip 216. Here the violet toner is transferred from drum to belt directly on top of the orange image on the belt 158. In this nip, the electric field is set so that most of the violet toner transfers to the belt. This procedure is repeated for the remaining two toner colors.

In FIG. 5, the worst case retransfer stress for the bottom left marking module 200 is now 4 downstream nips—three first transfer nips (216, 174, 176) plus the other second transfer nip (164). By comparison, a single ITB system having eight marking modules would have 7 downstream nips contributing to retransfer.

In order to maintain adequate registration or alignment between color separations produced on two separate ITB modules, it is necessary that sheet transport 160 provide stable predictable motion of the print media between transfer nips 162 and 164. This permits color separations to be produced on ITB module 112 so that they will align with separations already placed on the print media.

In the above description, it has been assumed that the image collection members upon which multiple color toner images are assembled are ITB modules. However, it is also possible to construct a system wherein one or more of the image collection members are photoreceptive members upon which multiple color toner images have been assembled. For example, printing system 50 may serve to deliver multiple color toner images to a second transfer station for transfer to print media. In accordance with the exemplary embodiments, it is possible for the print media to be previously or subsequently transported to or from a second transfer station so that additional color separations may be transferred to the media.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A printing system comprising:
a plurality of marking modules, wherein each marking module creates a single color separation of a multi-color image;
a first image collection member that collects superimposed color separations produced by a first set of said marking modules;
a second image collection member that collects superimposed color separations produced by a second set of said marking modules; and
a media transport that conveys print media along a defined direction;
wherein a first set of color separations is simultaneously transferred from said first image collection member to a print media at a first location on said transport and a second set of color separations is simultaneously transferred from said second image collection member to said media at a second location on said transport;
wherein at least one of said sets of color separations comprises at least two color separations.

2. The printing system of claim 1, wherein at least one of said image collection members is an intermediate belt.

3. The printing system of claim 1, wherein at least one of said image collection members is an intermediate drum.

4. The printing system of claim 1, wherein at least one of said image collection members is a photoreceptor member.

5. The printing system of claim 1, wherein said media transport is an electrostatic tacking transport.

6. The printing system of claim 1, wherein said color separations are composed of dry toner.

7. The printing system of claim 1, wherein said color separations are composed of liquid toner.

8. The printing system of claim 1, wherein said superimposed color separations are transferred to print media using a combination of electric field, mechanical pressure and heat.

9. A method of creating multi-color images on print media in a printing system, the method comprising:
creating color separations of a multi-color image via a plurality of marking modules, wherein each marking module creates a single color separation;
collecting superimposed color separations produced by a first set of said marking modules with a first image collection member;
collecting superimposed color separations produced by a second set of said marking modules with a second image collection member;
conveying print media along a defined direction in the printing system via a media transport; and
simultaneously transferring a first set of color separations from said first image collection member to a print media at a first location on said transport and a second set of color separations from said second image collection member to said media at a second location on said transport, wherein at least one of said sets of color separations comprises at least two color separations.

10. The method of claim 9, wherein at least one of said image collection members is an intermediate belt.

11. The method of claim 9, wherein at least one of said image collection members is an intermediate drum.

12. The method of claim 9, wherein at least one of said image collection members is a photoreceptor member.

13. The method of claim 9, wherein said media transport is an electrostatic tacking transport.

14. The method of claim 9, wherein said color separations are composed of dry toner.

15. The method of claim 9, wherein said color separations are composed of liquid toner.

16. The method of claim 9, wherein said superimposed color separations are transferred to print media using a combination of electric field, mechanical pressure and heat.
